(19) United States
(12) Patent Application Publication
(10) Pub. No.: US 2013/0337691 A1
(43) Pub. Date: Dec. 19, 2013

(54) THERMAL DISCONNECTION DEVICE

(71) Applicants: Martin Striewe, Horn-Bad Meinberg (DE); Christian Depping, Lemgo (DE); Sven Behnke, Dinslaken (DE)

(72) Inventors: Martin Striewe, Horn-Bad Meinberg (DE); Christian Depping, Lemgo (DE); Sven Behnke, Dinslaken (DE)

(73) Assignee: PHOENIX CONTACT GMBH & CO. KG, Blomberg (DE)

(21) Appl. No.: 13/992,438

(22) PCT Filed: Dec. 7, 2011
(86) PCT No.: PCT/EP2011/072114

§ 371 Date: Aug. 20, 2013

(30) Foreign Application Priority Data
Dec. 8, 2010 (DE) 102010061110.7

(51) Int. Cl. H01R 13/516

(52) U.S. Cl. CPC H01R 13/516
USPC 439/625

(57) ABSTRACT

The invention relates to a thermal disconnection device, comprising a first conductor section and a second conductor section, wherein the first conductor section is guided in a surrounding insulating body at least in some sections, wherein the first conductor section and the second conductor section are connected to each other at a detachable contact point, wherein the first conductor section is subjected to a force so that the first conductor section is moved into the surrounding insulating body when the contact point is detached.

The invention relates to a thermal disconnection device.

U.S. Pat. No. 6,430,019 is known from the prior art. In the solution found there, a shield-like body is moved into an intermediate space that develops. Nonetheless, the solution is not able to reliably suppress arcs because, due to the design, large conducting sections are present, which favor the formation of arcs during switching.

It is the object of the invention to make a thermal disconnection device available, which solves the known problems in an inventive manner.

The object is achieved according to the invention by a thermal disconnection device, comprising a first conductor section and a second conductor section, wherein the first conductor section is guided in a surrounding insulating body at least in some sections, wherein the first conductor section and the second conductor section are connected to each other at a detachable contact point, wherein the first conductor section is subjected to a force so that the first conductor section is moved into the surrounding insulating body when the contact point is detached.

In a further embodiment, the surrounding insulating body comprises a movable section, wherein the movable section is designed so that, in a first position, when the contact point is not detached, the conductor section is covered at least in some sections and in a second position, when the contact point is detached, the conductor section is moved behind the movable section into the insulating body, and the movable section fills the space that previously accommodated the conductor section.

In still another embodiment, the movable section is subjected to a force so that the movable section can be moved by the force from the first position to the second position when the conductor section has been pulled into the insulating body.

According to a further embodiment, the movable section is made at least in some sections of an outgassing material so as to be able to blow out a potentially developing arc.

According to still another embodiment, the surrounding insulating body comprises, at least in some sections, an outgassing material so as to be able to blow out a potentially developing arc.

In a further embodiment, the contact point comprises a soldering point.

In still another embodiment, the first conductor section has a substantially rectangular diameter.

According to still another embodiment, the first conductor section is subjected to a spring force so that the first conductor section is pulled into the surrounding insulating body when the contact point is detached.

According to a further embodiment, the movable section is subjected to a spring force so that the movable section can be moved by the force from the first position to the second position when the conductor section has been pulled into the insulating body.

According to still another embodiment, the first conductor section is connected to the neutral conductor or to ground or to the protective grounding conductor during operation.

The invention will be described hereafter in more detail based on preferred embodiments with reference to the accompanying drawings.

In the drawings:

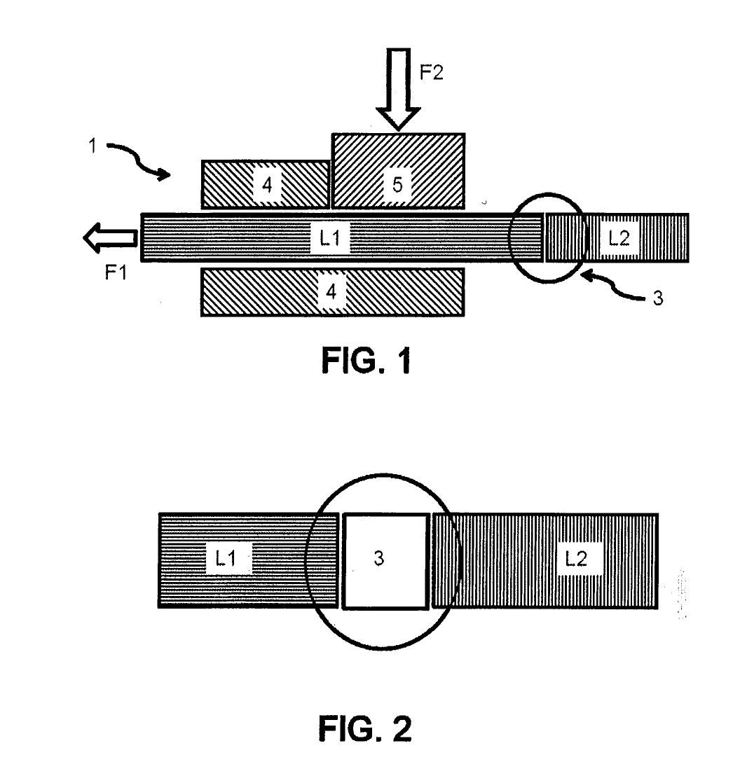

FIG. 1 is a schematic illustration of a thermal disconnection device according to the invention during operation;

FIG. 2 is a schematic detail of a thermal disconnection device according to the invention during operation;

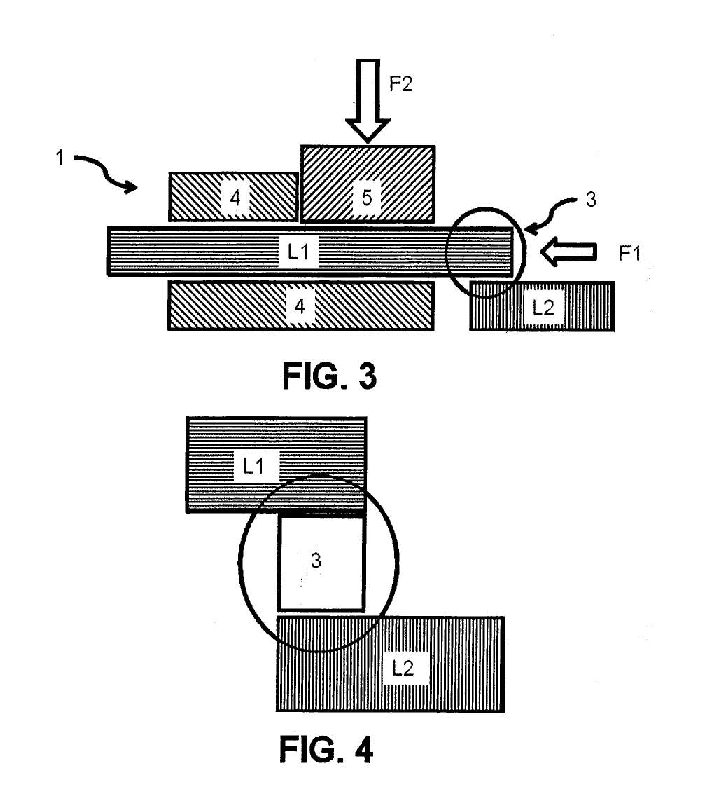

FIG. 3 is a schematic illustration of another embodiment of a thermal disconnection device according to the invention during operation;

FIG. 4 is a schematic detail of another embodiment of a thermal disconnection device according to the invention during operation;

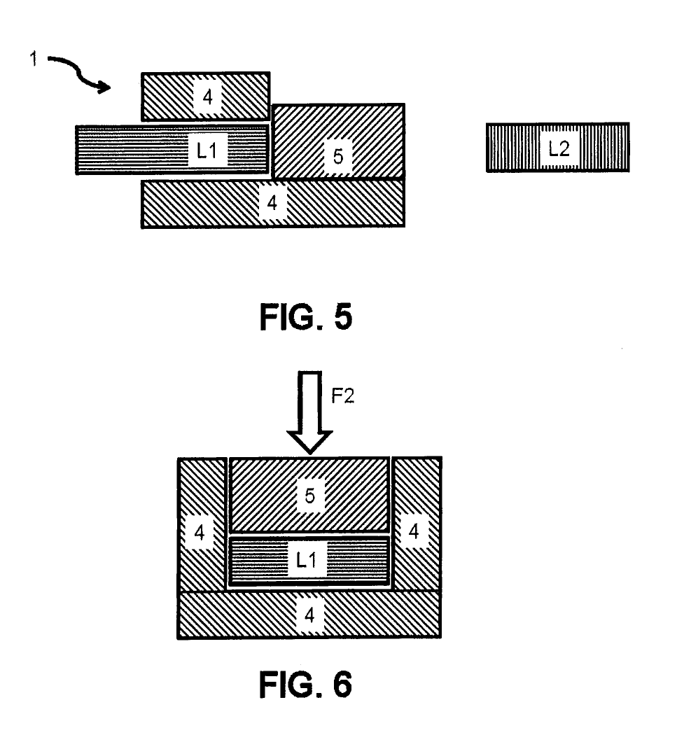

FIG. 5 is a schematic illustration of a thermal disconnection device according to the invention in the triggered state;

FIG. 6 is a cross-section of a schematic detail of a thermal disconnection device according to the invention during operation; and

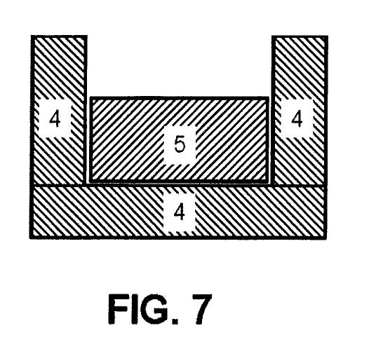

FIG. 7 is a cross-section of a schematic detail of a thermal disconnection device according to the invention in the triggered state.

FIG. 1 is a schematic illustration of a longitudinal sectional view of a thermal disconnection device 1. This thermal disconnection device 1 comprises a first conductor section L1 and a second conductor section L2. The first conductor section L1 and the second conductor section L2 are connected to each other by way of a thermally detachable contact 3 and are in electrical contact with each other.

At least some of the sections of the conductor section L1 are located in a surrounding insulating body, which here is represented by sections 4 and 5. Both section 4 and section 5 are produced from insulating material. The material for section 4 may differ from the material that is used for section 5. Section 4 and section 5 surround a certain section of the conductor section L1 and form a surrounding insulating body.

The first conductor section L1 is subjected to a force F1 so that the first conductor section L1 is moved into the surrounding insulating body 4, 5 when the contact point is detached.

The contact point 3 can be detached by way of a variety of mechanisms, for example thermally or by mechanical separation.

Moreover, it is also possible, as is shown in FIG. 1, to provide a pulling force F1, which pulls the first conductor section L1 into the surrounding insulating body 4, 5 or, as is shown in FIG. 3, to provide a pushing force F1, which pushes the first conductor section L1 into the surrounding insulating body 4, 5. Alternatively, a magnetic force is also conceivable.

Without describing this in detail, it goes without saying that similarly the surrounding insulating body 4, 5 could, of course, also be moved relative to the first conductor section L1. A pushing force or pulling force would then push or pull the surrounding insulating body 4, 5 over the conductor section L1. In this case, the conductor section L2 is advantageously also moved away from the conductor section L1. The movement can take place in the conductor direction and/or normal to the conductor direction. The essential aspect is that the distance of the conductor ends is increased.

Increasing the distance during triggering causes a potentially developing arc to be interrupted between the now separated conductor section L1 and conductor section L2, notably in the case of alternating current applications. This is possible because a zero crossing always occurs during a period with alternating current applications, so that the arc is interrupted.

This effect is supported by the move into the surrounding insulating body 4, 5.

This may not be sufficient for direct current applications in some circumstances.

So as to achieve a reliable cut-off process here as well, the surrounding insulating body 4, 5 can comprise a movable section 5.

The movable section 5 is designed to cover the conductor section L1 in a first position as shown in FIGS. 1 and 3, when the contact point 3 is not detached.

In a second position—as is shown in FIG. 5—when the contact point 3 is detached and the conductor section L1 has been moved behind the movable section 5 into the insulating body 4, the movable section 5 fills in the space that previously accommodated the conductor section L1.

This creates an effective option for causing the arc to be extinguished by filling the space that previously accommodated the conductor section L1 with the movable section 5.

Moreover, the thermal disconnection device can also be designed for the movable section 5 to be subjected to a force, so that the movable section 5 can be moved by the force F2 from the first position to the second position when the conductor section L1 has been moved into the insulating body 4.

It is also possible, for example, as is shown in FIGS. 1 and 3, to provide a pushing force F2, which moves the movable section 5 into the insulating body 4.

The force F2 can be applied by way of a spring, for example. Alternatively, a repelling magnetic force is also conceivable.

Alternatively, it also possible, of course, for the insulating body 4 to be moved together with the conductor section L1 relative to the section 5.

In addition, it is also conceivable, of course, to bring about the movement of the movable section solely by way of gravity. However, in this case, appropriate mounting must be assured.

As an alternative or in addition, in all embodiments the movable section 5 can be made, at least in some sections, of an outgassing material so as to be able to blow out a potentially developing arc.

As an alternative or in addition, in all embodiments the surrounding insulating body 4 can be made, at least in some sections, of an outgassing material so as to be able to blow out a potentially developing arc.

The detachable contact point 3 is preferably a soldering point. As an alternative, the contact point can also comprise thermally separable glue. Moreover, the contact point 3 provides an electrical connection of the conductor sections L1 and L2 during operation.

So as to cause the detachable contact point to be separated, the same can either be heated by way of self-heating or by heating from other components, for example a varistor or the like. As an alternative, of course heating by way of a heating element, for example, can also be provided so as to assure a faster switching time.

Without being limited to a particular conductor cross-section, a substantially rectangular cross-section has proven to be advantageous, because this allows the space that is freed up to be filled in the best possible manner. This is particularly advantageous for the extinguishing action. It goes without saying, of course, that this also means that the surrounding insulating body 4 and the movable section 5 are also shaped in the corresponding manner.

FIG. 6 shows a cross-section of a schematic detail of a thermal disconnection device according to the invention during operation, and FIG. 7 shows a cross-section of a schematic detail of a thermal disconnection device according to the invention in the triggered state.

The preferred rectangular cross-section of the conductor section L1 is clearly apparent. Corresponding thereto, the insulating body 4 is designed as a channel in the region of the movable section 5, the movable section being placed in this channel in a cover-like manner.

When the conductor section L1 is moved into the insulating body 4, the channel can be closed, as is shown in FIG. 7.

As is apparent from FIGS. 1 and 3, the contact point 3 can be provided in a suitable manner.

In FIG. 1, the contact point 3 is provided in a manner in which the conductor sections L1 and L2 are connected to each other by being butted against one another.

In FIG. 3, the contact point 3 is provided in a manner in which the conductor sections L1 and L2 are connected to each other so as to overlap one another in some sections.

However, it goes without saying that the shape of the contact point 3 and the arrangement thereof relative to the conductor sections L1 and L2 can also take on other forms.

During operation, the thermal disconnection device 1 can be connected so that the first conductor section L1 is connected to the neutral conductor or to ground or to the protective grounding conductor—known as the ‘cold’ end—during operation.

To the extent that the invention references a magnetic force, this magnetic force can be either present permanently, for example by introducing magnetic components, or it can be of a temporary nature, for example by introducing electromagnetic components.

Additionally, it goes without saying that in the case of magnetic forces, both repelling and attracting forces can be provided.

### LIST OF REFERENCE NUMERALS

Thermal disconnection device 1
First conductor section L1
Second conductor section L2
Detachable contact point 3
Surrounding insulating body 4
Movable section 5
Force F1
Force F2

1. A thermal disconnection device, comprising a first conductor section and a second conductor section, wherein the first conductor section is guided in a surrounding insulating body at least in some sections, wherein the first conductor section and the second conductor section are connected to each other at a detachable contact point, wherein the first conductor section is subjected to a force so that the first conductor section is moved into the surrounding insulating body when the contact point is detached.

2. The thermal disconnection device according to claim 1, wherein the surrounding insulating body comprises a movable section, wherein the movable section is designed so that, in a first position, when the contact point is not detached, the conductor section is covered at least in some sections, and in a second position, when the contact point is detached, the conductor section is moved behind the movable section into the insulating body, and the movable section fills the space that previously accommodated the conductor section.

3. The thermal disconnection device according to claim 2, wherein the movable section is subjected to a force so that the movable section can be moved by the force from the first position to the second position when the conductor section has been pulled into the insulating body.

4. The thermal disconnection device according to claim 3, wherein the movable section is made, at least in some sections, of an outgassing material so as to be able to blow out a potentially developing arc.

5. A thermal disconnection device according to claim 1, wherein the surrounding insulating body is made, at least in some sections, of an outgassing material so as to be able to blow out a potentially developing arc.

6. A thermal disconnection device according to claim 1, wherein the contact point comprises a soldering point.

7. A thermal disconnection device according to claim 1, wherein the first conductor section has a substantially rectangular diameter.

8. A thermal disconnection device according to claim 1, wherein the first conductor section is subjected to a spring force so that the first conductor section is pulled into the surrounding insulating body when the contact point is detached.

9. A thermal disconnection device according to claim 3, wherein the movable section is subjected to a spring force so that the movable section can be moved by the force from the first position to the second position when the conductor section has been pulled into the insulating body.

10. A thermal disconnection device according to claim 1, wherein the first conductor section is connected to the neutral conductor or to ground or to the protective grounding conductor during operation.

11. The thermal disconnection device according to claim 2, wherein the movable section is made, at least in some sections, of an outgassing material so as to be able to blow out a potentially developing arc.

12. A thermal disconnection device according to claim 2, wherein the first conductor section is subjected to a spring force so that the first conductor section is pulled into the surrounding insulating body when the contact point is detached.

13. A thermal disconnection device according to claim 3, wherein the first conductor section is subjected to a spring force so that the first conductor section is pulled into the surrounding insulating body when the contact point is detached.

14. A thermal disconnection device according to claim 4, wherein the first conductor section is subjected to a spring force so that the first conductor section is pulled into the surrounding insulating body when the contact point is detached.

15. A thermal disconnection device according to claim 5, wherein the first conductor section is subjected to a spring force so that the first conductor section is pulled into the surrounding insulating body when the contact point is detached.

16. A thermal disconnection device according to claim 4, wherein the movable section is subjected to a spring force so that the movable section can be moved by the force from the first position to the second position when the conductor section has been pulled into the insulating body.

17. A thermal disconnection device according to claim 5, wherein the movable section is subjected to a spring force so that the movable section can be moved by the force from the first position to the second position when the conductor section has been pulled into the insulating body.

18. A thermal disconnection device according to claim 6, wherein the movable section is subjected to a spring force so that the movable section can be moved by the force from the first position to the second position when the conductor section has been pulled into the insulating body.

19. A thermal disconnection device according to claim 7, wherein the movable section is subjected to a spring force so that the movable section can be moved by the force from the first position to the second position when the conductor section has been pulled into the insulating body.

20. A thermal disconnection device according to claim 4, wherein the movable section is subjected to a spring force so that the movable section can be moved by the force from the first position to the second position when the conductor section has been pulled into the insulating body.
